(19) United States
(12) Patent Application Publication
(10) Pub. No.: US 2017/0043489 A1
(43) Pub. Date: Feb. 16, 2017

(54) MULTIUSE HAND TOOL

(71) Applicant: Christopher Hoffman, Ft. Wayne, IN (US)

(72) Inventor: Christopher Hoffman, Ft. Wayne, IN (US)

(21) Appl. No.: 14/824,337

(22) Filed: Aug. 12, 2015

(51) Int. Cl. B26B 11/00; B25F 1/00

(52) U.S. Cl. CPC B26B 11/00; B25F 1/00

(57) ABSTRACT

A multi use tool that includes: a first end, where the first end includes a half hexagon shape; a second end, where the second end includes a cutting blade; and a stem connecting the first end with the second end. The stem may be used as a handle.

### BACKGROUND OF THE INVENTION

Field of Invention

The present invention relates to a multiuse hand tool that may be used for various purposes.

Description of Related Art

Individuals use multiple tools and instruments when camping, hiking and enjoying the outdoors. Many times individuals must have a small shovel, a cutting utensil such as a knife or even machete to cut, chop and dig various items to complete various camping or hiking activities. It is important to have various tools available to drive stakes, cut brush and to retrieve firewood as necessary. As a result it would be advantageous to have a multipurpose or all-in-one tool that allows the user to eliminate multiple instruments and to use a single instrument to address various tasks.

### SUMMARY OF THE INVENTION

The present invention relates to a multi use tool that includes: a first end, where the first end includes a half hexagon shape; a second end, where the second end includes a cutting blade; and a stem connecting the first end with the second end. The stem may be used as a handle.

### BRIEF DESCRIPTION OF DRAWINGS

FIG. 1 depicts a multipurpose tool in accordance with the present invention.

### DETAILED DESCRIPTION

The present invention relates to a multiuse hand tool that provides unique edging and maneuverability to accomplish various tasks. The present invention includes a cutting tool that has a knifelike shape with a protruding half hexagon head. The tool can be used to cut, split, chop and dig through various materials surfaces. Further the tool is balanced in weight in order to provide functions related to a shovel. The present invention may be used in various tasks related to camping, hiking and other outdoor activity.

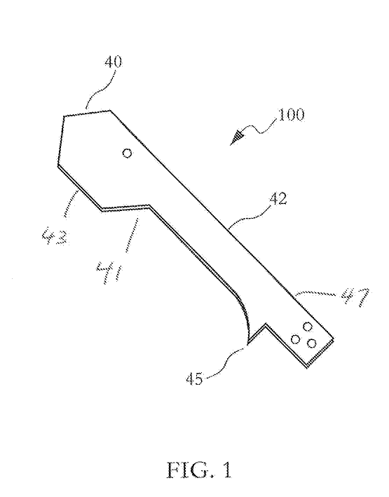

In reference to FIG. 1, a multiuse hand tool in accordance with the present invention is depicted. The multiuse hand tool 100 is shown. The multiuse hand tool 100 includes a first end 40 and cutting blade 45 at the opposing end. The first end 40 has a half hexagon-shaped head and the cutting blade 45 includes a sharp pointed edge for use by the user. Between the cutting blade 45 and hexagon head 40 is a stem that may be provided for use as a handle in using the multiuse tool 100. This tool 100 as stated may be used as a shovel, cutting or chopping tool.

The tool may be manufactured with steel, wood and other materials in order to accomplish the functions related to the use of the tool. Further a sheath may be provided with a fire starter and a sharpening stone to be used in conjunction with the hand tool 100. The instant invention has been shown and described in what it considers to be the most practical and preferred embodiments. It is recognized, however, that departures may be made there from within the scope of the invention and that obvious modifications will occur to a person skilled in the art.

1. A multi use tool comprising:
a. a first end, where the first end includes a half hexagon shape;
b. a second end, where the second end includes a cutting blade, where the tool is flat from the first end to the second end;
c. a flat edge extending from the first end;
d. a stem connecting the first end with the second end; and
e. a base, wherein the base extends at an angle from the flat edge forming a base for the stem.

2. The multi use tool according to claim 1, where the stem is used as a handle.
